(19) United States
(12) Patent Application Publication
(10) Pub. No.: US 2011/0016688 A1
(43) Pub. Date: Jan. 27, 2011

(54) Tool

(76) Inventor: Richard Townsend, Perth (AU)

Correspondence Address: EDELL, SHAPIRO & FINNAN, LLC, 1901 RESEARCH BOULEVARD, SUITE 400, ROCKVILLE, MD, 20850, US

(21) Appl. No.: 12/846,917

(22) Filed: Jul. 30, 2010

Related U.S. Application Data
(63) Continuation of application No. PCT/AU2009/000084, filed on Jan. 29, 2009.

(30) Foreign Application Priority Data
Jan. 31, 2008 (AU) 2008900423

(51) Int. Cl. B23P 19/04; B25C 11/00

(52) U.S. Cl. 29/426.5; 254/131; 29/267

(57) ABSTRACT

A tool for manipulating an article includes an operative portion. The operative portion includes a convex surface defined by a first curved segment extending substantially from a first end having a radius greater than at least one further subsequent curved segment, and a concave surface opposite the convex surface. In use, one of the convex and concave surfaces is engageable with an article and the other of the convex and concave surfaces is engageable with a work-piece such that the convex and concave surfaces are cooperable to establish a fulcrum point between the work-piece and the other surface.

### FIELD OF THE INVENTION

The present invention relates to a tool.

### BACKGROUND OF THE INVENTION

Automobiles have many removable parts. Such parts include, but are not limited to, door trims, dashboard components, interior paneling, body protection moulding, badges and name plates, chrome strips, bumperbar inserts, inner guard liners, under bonnet insulators, boot linings, windscreen surrounds and the like. These are retained in position by a variety of fastening means such as plastic clips, trim plugs, metal spring clips, double sided tape, integrated clips and adhesives of various types.

Current tools for removing these parts have the tendency to damage the fasteners or peripheral parts of the automobile.

The present invention is intended to provide a new tool useful for, inter alia, assisting in the manipulation and/or removal of such fastening means so that such damage is minimised if not eliminated.

It is to be understood that, if any prior art publication or prior use is referred to herein, such reference(s) do not constitute an admission that the publication or use forms any part of the common general knowledge in the art, in Australia, or any other country.

### SUMMARY OF THE INVENTION

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

According to a first aspect of the present invention there is provided a tool for manipulating an article, said tool comprising:

an operative portion having;
a convex surface defined by a first curved segment extending substantially from a first end having a radius greater than at least one further subsequent curved segment; and,
a concave surface opposite said convex surface;

wherein, in use, one of said convex or concave surfaces is engageable with an article and the other of said convex or concave surfaces is engageable with a work-piece so said convex and concave surfaces are cooperable so that a fulcrum point is established between the work piece and said other surface.

According to a second aspect of the present invention there is provided a tool for manipulating an article, said tool comprising:

an operative portion having;
a convex surface defined by a first curved segment extending substantially from a first end having a radius different to at least one further subsequent curved segment; and,
a concave surface opposite said convex surface;

wherein, in use, one of said convex or concave surfaces is engageable with an article and the other of said convex or concave surfaces is engageable with a work-piece so said convex and concave surfaces are cooperable so as to establish a fulcrum point between said other surface and said work piece, whereby, in operation, said fulcrum point moves along said other surface when the operating portion is used.

In a further embodiment, during use, the fulcrum point moves along said other surface so as to increase the leverage to said article gradually reducing the applied force thereto.

In one embodiment, the operative portion may be formed with a shaft at an end opposite the first end of the operative portion.

In a further embodiment, the ratio of the radius of the first curved segment of said convex surface to a second curved segment of said convex surface is substantially greater than 1.0.

In another embodiment, the ratio of the radius of said second curved segment subsequent to a subsequent curved segment of said convex surface is substantially greater than 1.0.

In another embodiment, the curve definition for the concave surface is substantially the same as that for the first surface.

In one embodiment, the definition of each of said convex or concave surfaces may further comprise at least one transitional curve segment between adjacent curve segments.

In a further embodiment, the operative portion further comprises a receiving portion for engaging an article by either of said convex or concave surfaces.

In yet another embodiment, the receiving portion is formed substantially central of the operative portion.

In another embodiment, the receiving portion comprises a cut-away portion extending from the first end of the operative portion.

In a further embodiment, the cut-away portion is of uniform width along its length.

In an alternative embodiment, the cut-away portion may comprise a variable width along its length. The cut-away section may be shaped in accordance with that of a specific article.

In yet a further embodiment, the operative portion is in the form of a claw.

In a further embodiment, the tool may comprise a handle portion at said opposite end and attachable to said shaft.

In a further embodiment, the shaft may comprise an engagement means for engaging a complimentary recess formed within said handle portion. The engagement means may comprise at least one protrusion configured to extend radially outward of said shaft and capable of being inserted to said complimentary recess to key into the handle portion.

According to a third aspect of the present invention there is provided a method for manipulating an article within a work-piece using the tool hereinbefore described. Said method comprising the steps of:

engaging said article with said convex or concave surface;

leveraging said article from said work-piece.

In one embodiment, operation of the tool to leverage an article is by the handle portion being moved toward a plane within which the surface of the work-piece resides within.

According to a fourth aspect, there is provided a tool for manipulating an article, said tool comprising:

an operative portion having a convex surface having a curve which tightens as the curve extends from a tip of the operative portion; and a concave surface opposite the convex surface having a curve which tightens as the curve extends from the tip, wherein when the convex surface is contacted with a work-piece a fulcrum point is formed such that the position of the fulcrum point on the convex surface is selectable according to where the convex surface is contacted with the work-piece.

In a further embodiment, when the concave portion is contacted with an article to be manipulated a lever arm is formed between the point of contact on the concave surface and the fulcrum point, such that the point of contact on the concave surface is selectable.

In another embodiment, said curve of said convex surface is continuous.

In yet another embodiment, said curve of said convex surface comprises more than one discrete curve segment.

### BRIEF DESCRIPTION OF THE DRAWINGS

Preferred embodiments of the present invention will now the described, by way of example only, with reference to the accompanying drawings, in which:

FIG. 1 shows a plan view of one embodiment of the present invention;

FIG. 2 shows a side elevation view of the embodiment shown in FIG. 1;

FIG. 3 shows a perspective view of the embodiment shown in FIG. 1 and FIG. 2;

FIG. 4 shows one embodiment of a handle portion used in accordance with the embodiment of the present invention in FIGS. 1 through 3;

FIG. 5 shows a plan view of the embodiment of the handle portion shown in FIG. 4 in conjunction with the embodiment of the invention shown in FIGS. 1 through 3;

FIG. 6 shows the view of the embodiment presented in FIG. 2 with the relevant construction radii overlayed;

FIG. 7A shows the embodiment shown in FIGS. 1 through 7 placed in a position for removing an article having hypothetical positions T and T′;

FIG. 7B shows the embodiment shown in FIGS. 1 through 7 placed in a different position for removing an article having hypothetical positions T and T′;

FIG. 8A shows the embodiment of the present invention shown in FIGS. 1 through 3 in a first step of a first mode of operation;

FIG. 8B shows the embodiment of the present invention shown in FIGS. 1 through 3 in a second step of operation;

FIG. 8C shows the embodiment of the present invention shown in FIGS. 1 through 3 in a third step of operation;

FIG. 8D shows the embodiment of the present invention shown in FIGS. 1 through 3 in a fourth step of operation;

FIG. 8E shows the embodiment of the present invention shown in FIGS. 1 through 3 in a fifth step of operation;

FIG. 9A shows the embodiment of the present invention shown in FIGS. 1 through 8 when in a first step of a second mode of operation; and,

FIG. 9B shows the scenario shown in FIG. 9A further advanced.

### DETAILED DESCRIPTION OF THE PREFERRED EMBODIMENTS OF THE INVENTION

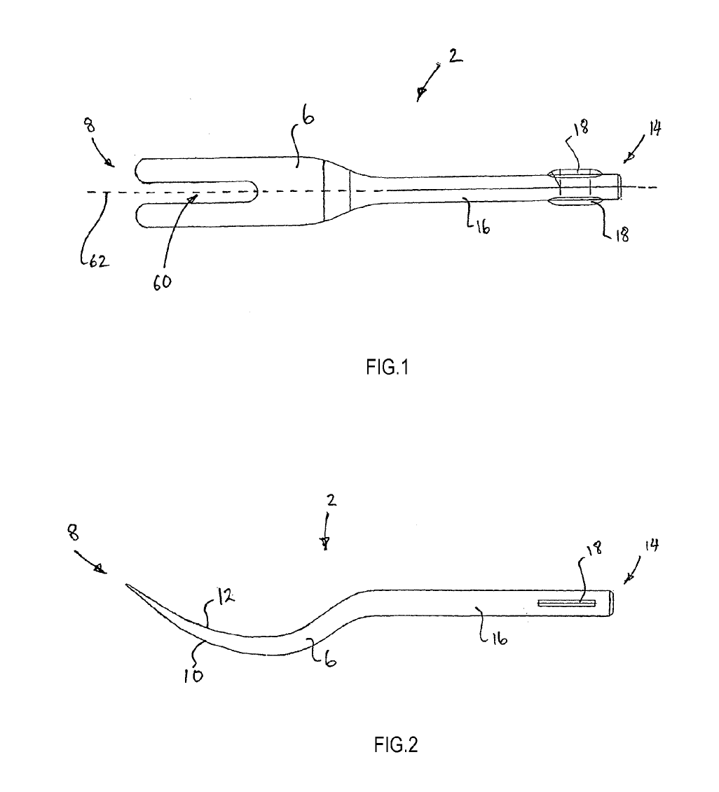

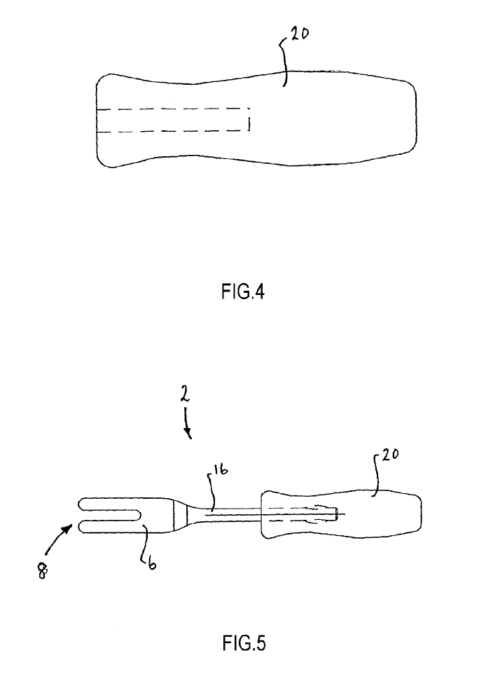

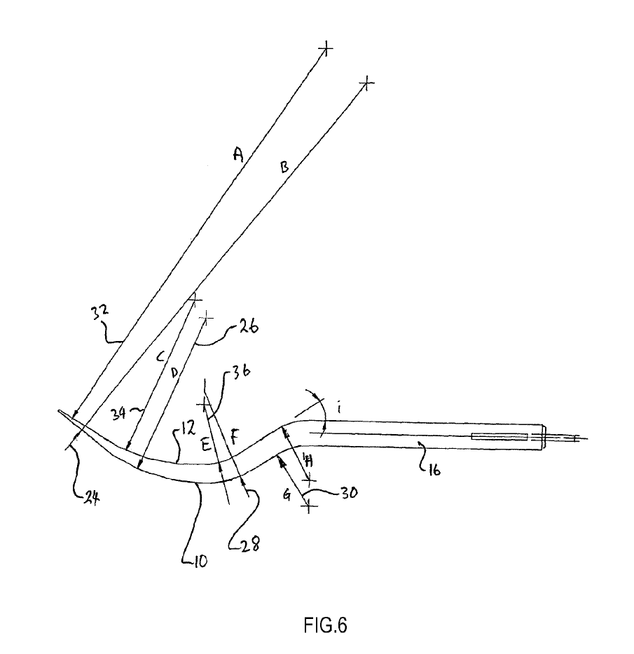

With reference to FIGS. 1 through 7 there is shown one embodiment of a tool 2 for manipulating or leveraging an article 4. The tool 2 comprises an operative portion 6 having a first end 8 and a convex surface 10 extending substantially therefrom. The convex surface comprises a first curved segment 24 (shown in FIG. 6) adjacent the first end 8 and has a radius greater than at least one further subsequent curved segment further defining the first curved surface 10.

The operative portion 6 further comprises a concave surface 12 that is opposite the convex surface 10. When the tool 2 is in use, one of the convex 10 or concave 12 surfaces engages with the article 4 whereby the other of the convex 10 or concave 12 surfaces becomes in contact with a work-piece 5. Between both two contact points the convex 10 and concave 12 surfaces are co-operable so that a fulcrum point is established between the work-piece 5 and the contacting surface. During operation, the fulcrum point moves along either the convex 10 or concave 12 surfaces that contacts the work-piece 5 so that the leverage supplied to the article 4 and the applied force gradually reduces.

With reference to FIG. 6, the first curved segment 24 has a radius B. The convex surface 10 is further defined by a second 26 and third 28 curved segments that are defined by radii D and F respectively, each of which is less than B. A fourth curved segment 30 having a radius G completes the definition of the convex surface 10.

The concave surface 12 of the operative portion 6 is formed opposite the first curved surface 10. With reference again to FIG. 6, the concave surface 12 comprises a fifth curved segment 32 that extends substantially from the first end 8 of the operative portion 6 and defined by radius A. Further, subsequent curve segments 34 and 36 define the sixth and seventh curved segments of the concave surface 12 having radii C and E respectively. A further curve segment 38 defined by radius H completes the definition of the concave surface 12 of the embodiment shown in FIG. 6.

For the embodiment shown in FIG. 6, the first curved segment 24 of the convex surface 10 and the fifth curved segment 32 of the concave surface 12 both correspond with one another as both extend from substantially the first end 8 of the operative portion 6. For the embodiment shown, the respective radii of curve segments 24, 32 are the same. It will be appreciated that the centres of these curved segments (24,32) are not the same so as to allow for a degree of thickness between both surfaces to provide sufficient strength and stiffness to the operative portion 6 when leveraging an article 4. As such, the relative location of the centres of each corresponding curve segment influences the thickness of the corresponding curved sections.

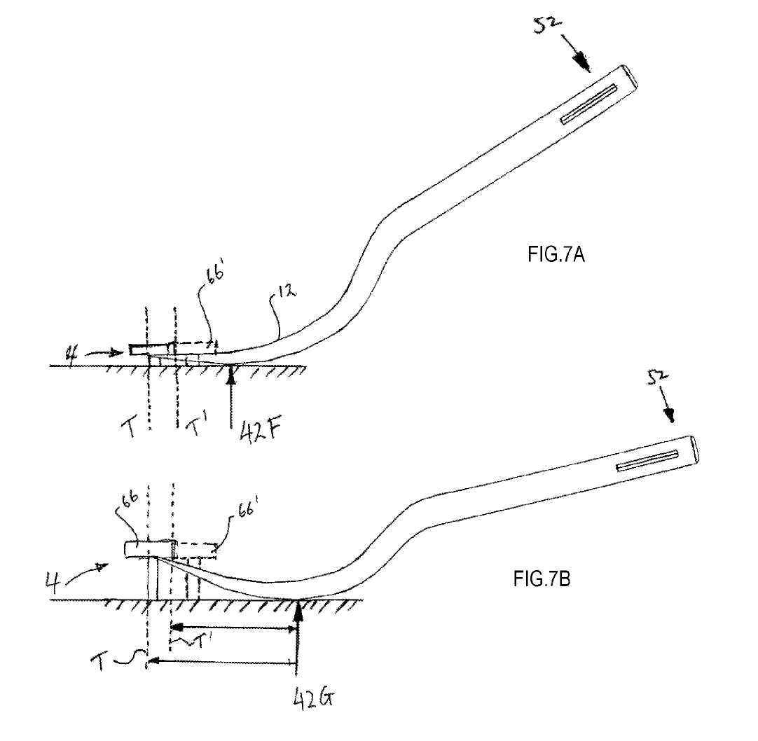

The second curved segment 26 of the convex surface 10 corresponds with the sixth curved segment 34 of the concave surface 12. For the embodiment shown, the radii of both these surfaces is the same and is determined to be substantially less than that for curved segments 24 and 32 of the convex surface 10. For both sets of corresponding curves, it has been determined that the resulting curve definition for the convex and concave surfaces results in an optimal curve definition for establishing a wide range of fulcrum positions for leveraging an article 4 during operation. Typically, during operation, the tool 2 is rotated about the article 4 in a direction 52 that is substantially towards a plane within which both the surface of the work-piece 5 and the fulcrum point reside as shown in FIG. 7. Furthermore, the resulting curve definition of the convex 10 and concave 12 surfaces optimises the following criteria used in the developmental process:

Effectiveness of intended purpose

Strength/Durability

Ergonomics

Maximum leverage

Control

Versatility

Lifting Height

Advancement over existing designs

Aesthetics

As will be appreciated, use of multiple curved segments having different radii to define a single curve inherently generates a point of transition between adjacent curve segments. The severity or abruptness of this transition point is generally influenced by the difference in the lengths of the radii of the adjacent curve segments as well as the centres of curvature of the respective curve segments. The transition point may be ‘softened’ so as to impart a further curve segment that effectively provides a transition curve that links the two adjacent curve segments together. For the curve definition of the convex and concave surfaces of the present invention, it will be appreciated that at least one transition point or transition curve segment may be used to ‘link’ each of the adjacent curve segments so as to define the curvatures appropriately.

The effect of a transition point on the operation of the tool 2 may be that there is a perceivable change felt by the user as the fulcrum point moves shifts from one curve segment to the next when contacting the surface of the work-piece 5. If the transition point is smoothed or rounded to form a transitional curve segment between adjacent curve segments, this smoothing may soften, to the user, the perception of the fulcrum point shifting. In some instances, after repeated use of the tool 2, it may be preferable to a user for the tool 2 to have a transition point to better signal a change in leverage characteristic as the fulcrum point shifts. This may impart a better ‘feel’ to the user during operation of the tool 2. This may be important when removing delicate articles or removing tightly held articles in delicate locations subject to damage.

For the embodiment of the operative portion 6 shown in FIGS. 1 through 7, the geometrical parameters defining the convex and concave surfaces may be tabulated as follows:

| Curve Segment | Radius^{π} | Centre X^{ψ} | Centre Y^{Ω} |
|---|---|---|---|
| A | 1.0 | 0.84 | 5.62 |
| B | 1.0 | 0.68 | 5.13 |
| C | 0.37 | 1.29 | 1.89 |
| D | 0.37 | 1.24 | 1.63 |
| E | 0.13 | 1.24 | ? |
| F | 0.20 | 1.24 | 1.3 |
| G | 0.13 | 0.86 | 1.06 |
| H | 0.13 | 0.86 | 0.69 |

Where,
^{π}normalised with respect to the radius of the first curved segment of the convex surface 10;
^{ψ}normalised with respect to the effective length (horizontal plane) of the operative portion 6; and,
^{Ω}normalised with respect to the effective depth (vertical plane) of the operative portion 6;

In the embodiment of the present invention shown in FIGS. 1 through 9, the operative portion 6 further comprises a receiving portion 60 for engaging the article 4. The receiving portion 60 comprises a cut-away section, forming a gap between tines that form the operative portion 6, that extends substantially from the first end 8 of the operative portion 6 in a direction that is substantially aligned with a longitudinal axis 62 of the tool 2. In the embodiment shown, the receiving portion 60 comprises a uniform width along its length. It will be appreciated however that the width may vary along its length and may be appropriately configured so as to receive articles of specific shapes.

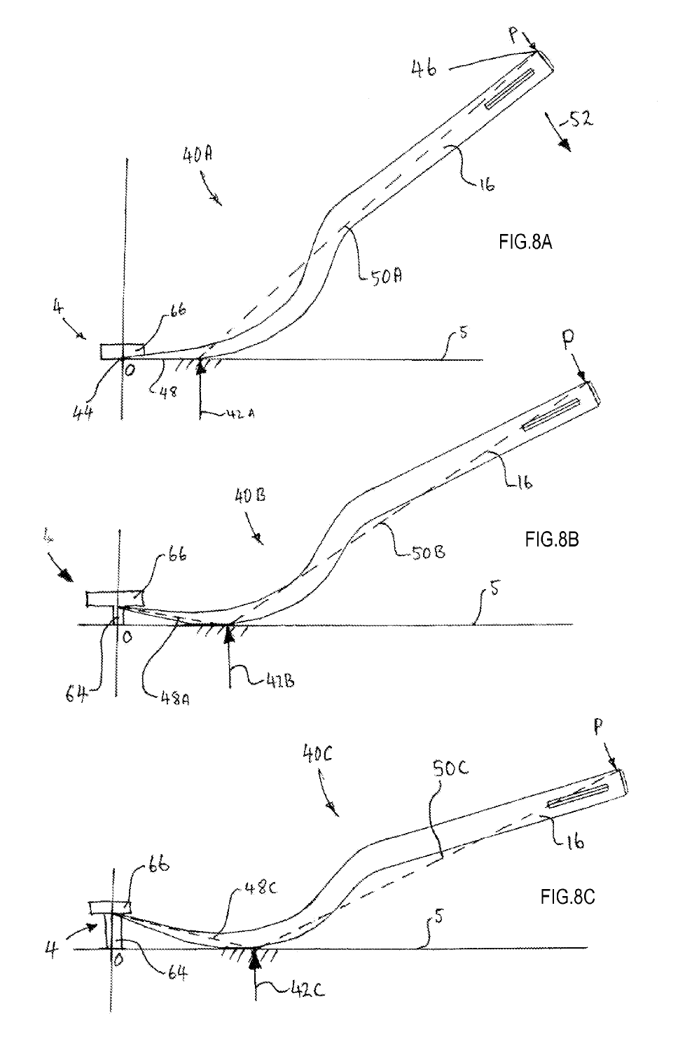

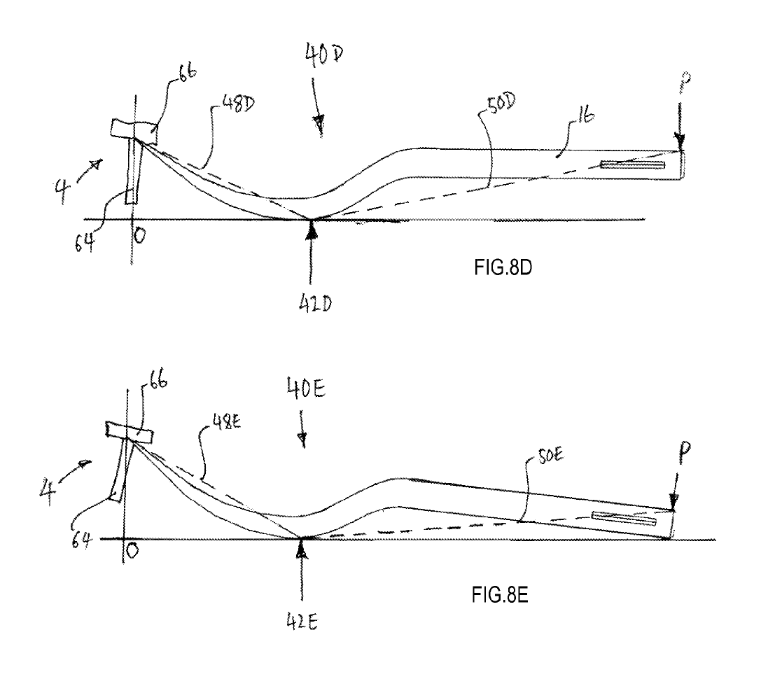

In the current embodiment, engagement of an article 4, such as a plug, will normally require a first portion 64 of the article 4, such as a shaft, to be received by the receiving portion 60 so that the concave surface 12 may contact a second portion 66 of the article 4, such as a head of the plug. Generally, the first portion 64 of the article 4 will not be of a dimension greater than the width of the receiving portion 60 so as it may fit within the receiving portion 60. Furthermore, the second portion 66 of the article 4 contacted by the concave surface 12 will generally extend outward from the first portion 64 and have a width no less than the width of the receiving portion 60 so that it may be captured by the concave surface 12 of the operative portion 6. Accordingly, the degree of leverage required may be appropriately selected (shown in FIGS. 8A and 8B) by a user whereby the first portion 64 of the article 4 is positioned within the receiving portion 60 so that the desired distance from the fulcrum point and the contact point between the first portion 64 and the convex surface 10 is obtained. This distance is referred to subsequently as the first lever arm 48 (FIG. 8).

FIG. 7 shows how the user may select different length first lever arms 48. FIG. 8A shows the tool 2 engaging article 4 at two of many possible positions on the concave surface 12; position T and position T′. As the fulcrum point 42F remains the same, the lever arm provided to the article 4 at positions T and T′ respectively is different. It will be appreciated that the lever arm corresponding with position T′ will be smaller than that corresponding to position T.

FIG. 7B shows a different situation whereby the article 4 is slightly further elevated initially. In this instance, the tool 2 has been placed at a different orientation so the fulcrum point 42F is further shifted along the convex surface 10. For the situation shown, both lever arms have increased in length from that shown in FIG. 7A. This has the effect of reducing the force applied to the article (discussed later) but increases the length of the respective first lever arms 48. However, the lever aim corresponding to position T′ still remains longer than that for position T. Accordingly, for the mode of operation shown in FIG. 7, the user may actively select a suitable lever arm at any stage during the removal of an article 4 by gauging the placement of the concave surface 12 in relation to a contacting portion of the article 4, and, the orientation of tool 2 with respect to the contact point between the convex surface 12 and the work-piece 5.

In an alternative embodiment (not shown), the operative portion 6 may not comprise a receiving portion 60. In this embodiment, the first end 8 of the operative portion 6 directly engages the article 4 so that a portion of the concave surface 12 comes in contact with the article 4.

FIG. 8 shows a first mode of operation of the tool 2. FIGS. 8A through 8E show the operation of the tool 2 when engaging article 4 at various consecutive positions from an initial condition 40A (shown in FIG. 8A). FIG. 8A shows the convex surface 10 of the operative portion 6 resting against the surface of a work piece 5. The operative portion 6 is positioned relative the article 4 so as the concave surface 12 may engage with the second portion 66 of the article 4.

As the shaft 16 of the tool 2 is lowered in direction 52, two sets of reaction forces become active; a first reaction force due to the contact between the second portion 66 of the article 4 with the concave surface 12 of the operative portion 6, and, a second reaction force due to contact between the convex surface 10 and a portion of the surface of the work-piece 5. The latter contact effectively establishes a fulcrum point 42A for the condition 40A shown. It will be realised that two levers arms are now active that operate through the fulcrum point 42 to provide leverage to the article 4; a first lever arm 48 defined by the distance from the fulcrum point 42A to the tip 44 of the operative portion 6, and, a second lever arm 50 defined from the fulcrum point 42A to a portion 46 of the shaft 16 where a leverage force P is applied. The leverage force P will be applied by a user and may generally be applied at any arbitrary point along the shaft 16. For the purposes of demonstrating the operation of the tool 2, the applied force P is taken to be applied at the distal end of the shaft 16 and acts in a direction that is orthogonal to the second lever arm 50 in all instances in FIGS. 8A through 8E.

FIG. 8B shows the tool 2 now positioned after a small rotation in direction 52. As such, the contact point between the convex surface 10 and the work-piece 5 has now shifted as a result of the rotation. As a consequence of this action, as well as and the curvature of the convex surface 10, the fulcrum point 42B has moved away from the article 4 and, in a relative sense, shifted away from the previous fulcrum point 42A. As such, the first lever arm 48B (between the article 4 and the fulcrum point 42B) has increased.

FIGS. 5C through 5E show subsequent positions of the tool 2 where it is shown, using corresponding notation, that the fulcrum point 42 shifts further away from article 4 as the tool 2 is rotated in direction 52. As such, it will be appreciated that the first lever arm 48 increases in length. The movement of the fulcrum position 42 (measured from the origin O), as a function of the effective length of the operative portion 6, may be tabulated as follows for each scenario shown in FIG. 8:

| Position | Fulcrum Pt (%) |
|---|---|
| Figure 7A | 0.25 |
| Figure 7B | 0.34 |
| Figure 7C | 0.44 |
| Figure 7D | 0.50 |
| Figure 7E | 0.52 |

It will be appreciated that the length of the first lever arm 48 can be found from a trigonometric relationship and is dependent upon the angle θ and the length of the fulcrum point 42 to the origin O.

It would be understood that the length of the second lever arm 50 reduces as a function rotation of the tool 2 by the applied force as shown in FIGS. 8A through 8E. For the same applied force P throughout the movements shown in FIG. 8, as the second lever arm 50 reduces and so too does the effective moment about the fulcrum point 48. As a consequence of this, the applied moment to the article 4 also reduces as does the applied force A to article as a result of the first lever arm 48 increasing. Accordingly, the applied force A to the article 4, per unit of applied force P, is found to be equal to the ratio of the lengths of the second lever arm 50 to the first lever arm 48. The effect of the curvature of the convex surface 10 is that the ratio of the second lever arm 50 to the first lever arm 48 reduces as the tool rotates in direction 52. This can be tabulated as follows:

| Position | First Lever Arm^{Φ} | Second Lever Arm^{Φ} | Ratio (2^{nd}/1^{st}) |
|---|---|---|---|
| Figure 7A | 0.25 | 1.42 | 5.7 |
| Figure 7B | 0.35 | 1.36 | 3.9 |
| Figure 7C | 0.46 | 1.27 | 2.8 |
| Figure 7D | 0.52 | 1.15 | 2.2 |
| Figure 7E | 0.57 | 1.1 | 1.9 |

Where,
^{Φ}normalised with respect to the effective length of the operative portion 6.

Often, removal of articles such as clips used in automobiles requires a large amount of force to initially overcome the friction forces which keep them in place. Once the article has been dislodged from its lodged state, less force, if any, is required to overcome any residual frictional forces as the article is removed. A significant inconvenience can result in too much force continuing to be applied once the initial dislodgement has occurred which can result in loss of the article, i.e., complete dislodgement of the article in one stroke. In a worst case the article can be catapulted from prior tools.

With the greatest amount of force imparted to the article 4 at the start of the leveraging movement (FIG. 8A), the tabulated data shows that the force applied to the article 4 reduces throughout continuation of the movement in a relatively consistent manner. The overall effect of the above is that the user does not have to consciously vary the applied force P as this is automatically controlled due to the curvature of the convex surface varying or shifting the fulcrum point during operation.

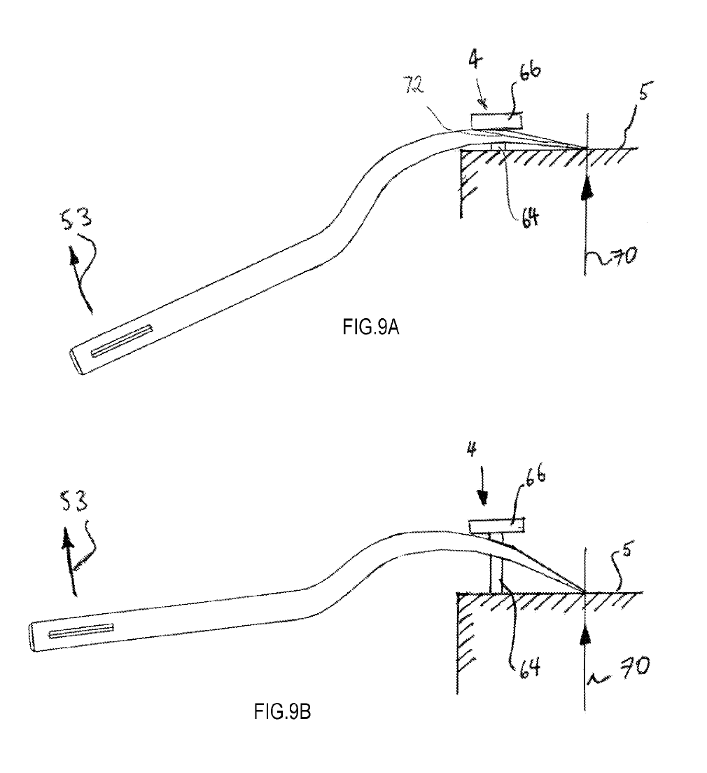

A second mode of operation of the tool 2 is shown in FIGS. 9A and 9B. In this mode of operation, FIG. 9A shows the initial position of the tool 2 engaging an article 4 so that the first end 8 of the concave surface 12 contacts the surface of the work-piece 5. In this instance, a fulcrum point 70 is formed and the first lever arm 72 is established between the second portion 66 of the article 4 and the convex surface 10. When the shaft 16 is rotated in the direction 53, as shown in FIG. 9B, the article 4 is leveraged from its lodgment in the work-piece 5. During this mode of operation of the tool 2, the fulcrum point 70 does not automatically move. In most instances, the contact point between the convex surface 10 and the second portion 66 of the article 4 will remain substantially the same, however, this will depend upon the shape of the article and the nature of the contact point with the convex surface 10. During this mode of operation, it will be appreciated that the user may re-position the tool relative the article 4 so as to increase or decrease the length of the lever arm 72 accordingly.

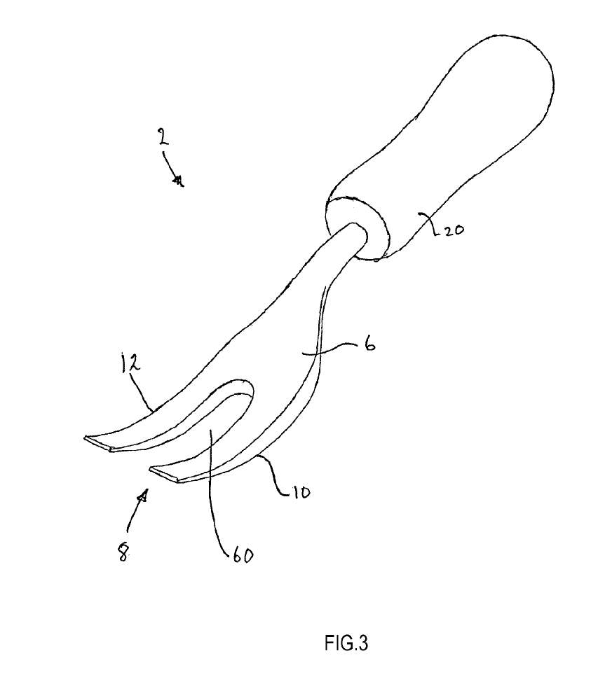

For the embodiment shown in FIGS. 1 through 9, the tool 2 may further comprise an engaging means 14 at an end opposite the first end 8 to allow the shaft 16 to engage with a handle portion 20 (shown in FIGS. 3 through 5). The engaging means 14 may, for example, comprise a portion of the shaft 16 having at least one protrusion 18 capable of engaging with a complimentary recess 22 formed in the handle portion 20 for keying the shaft 16 (and the tool 2) appropriately into position. It may be realised that other ways of engaging the tool 2 with handle portion 20 may be readily realised by one skilled in the art. In an alternative embodiment, shaft 16 may be fastened to the handle portion 20 by using any known mechanical fastening means known in the art. Further, an epoxy glue system may also be used solely, or, in combination with a mechanical fastening system, for fastening the shaft 16 into a handle portion 20.

It will be understood to persons skilled in the art of the invention that many modifications may be made without departing from the spirit and scope of the invention.

What is claimed:

1. A tool for manipulating an article, said tool comprising:
an operative portion comprising:
a convex surface defined by a first curved segment extending substantially from a first end having a radius greater than at least one further subsequent curved segment; and
a concave surface opposite said convex surface;
wherein, in use, one of said convex and concave surfaces is engageable with an article and the other of said convex and concave surfaces is engageable with a work-piece such that said convex and concave surfaces are cooperable to establish a fulcrum point between the work-piece and the other surface.

2. A tool according to claim 1, wherein the operative portion may be formed with a shaft at an end opposite the first end of the operative portion.

3. A tool according to claim 1, wherein the ratio of the radius of the first curved segment of said convex surface to a second curved segment of said convex surface is substantially greater than 1.0.

4. A tool according to claim 3, wherein the ratio of the radius of said second curved segment subsequent to a subsequent curved segment of said convex surface is substantially greater than 1.0.

5. A tool according to claim 1, wherein the curve definition for the concave surface is substantially the same as that for the first surface.

6. A tool according to claim 1, wherein the definition of each of said convex and concave surfaces may further comprise at least one transitional curve segment between adjacent curve segments.

7. A tool according to claim 1, wherein the operative portion further comprises a receiving portion for engaging an article by either of said convex and concave surfaces.

8. A tool according to claim 7, wherein the receiving portion is formed substantially central of the operative portion.

9. A tool according to claim 7, wherein the receiving portion comprises a cut-away portion extending from the first end of the operative portion.

10. A tool according to claim 9, wherein the cut-away portion is of uniform width along its length.

11. A tool according to claim 9, wherein the cut-away portion is shaped in accordance with that of a specific article.

12. A tool according to claim 1, wherein the operative portion is in the form of a claw.

13. A tool according to claim 12, wherein the tool comprises a handle portion at said opposite end and attachable to said shaft.

14. A method for manipulating an article within a work-piece using the tool of claim 1, said method comprising the steps of:
engaging said article with said convex or concave surface; and
leveraging said article from said work-piece.

15. A tool for manipulating an article, said tool comprising:
an operative portion comprising a convex surface having a curve which tightens as the curve extends from a tip of the operative portion; and
a concave surface opposite the convex surface having a curve which tightens as the curve extends from the tip;
wherein, when the convex surface is contacted with a work-piece, a fulcrum point is formed such that the position of the fulcrum point on the convex surface is selectable according to where the convex surface is contacted with the work-piece.

16. A tool according to claim 15, wherein, when the concave portion is contacted with an article to be manipulated, a lever arm is formed between the point of contact on the concave surface and the fulcrum point such that the point of contact on the concave surface is selectable.

17. A claim according to claim 15, wherein said curve of said convex surface is continuous.

18. A claim according to claim 15, wherein said curve of said convex surface comprises more than one discrete curve segment.

19. A tool for manipulating an article, said tool comprising:
an operative portion comprising:
a convex surface defined by a first curved segment extending substantially from a first end having a radius different to at least one further subsequent curved segment; and
a concave surface opposite said convex surface;
wherein, in operation, one of said convex and concave surfaces is engageable with an article and the other of said convex and concave surfaces is engageable with a work-piece such that said convex and concave surfaces are cooperable to establish a fulcrum point between said other surface and said work piece, and said fulcrum point moves along said other surface so as to increase the leverage to said article gradually reducing the applied force thereto.

20. A tool according to claim 19, wherein the operative portion is formed with a shaft at an end opposite the first end of the operative portion.

21. A tool according to claim 19, wherein the ratio of the radius of the first curved segment of said convex surface to a second curved segment of said convex surface is substantially greater than 1.0.

22. A tool according to claim 21, wherein the ratio of the radius of said second curved segment subsequent to a subsequent curved segment of said convex surface is substantially greater than 1.0.

23. A tool according to claim 19, wherein the curve definition for the concave surface is substantially the same as that for the first surface.

24. A tool according to claim 19, wherein the definition of each of said convex and concave surfaces comprises at least one transitional curve segment between adjacent curve segments.

25. A tool according to claim 19, wherein the operative portion further comprises a receiving portion for engaging an article by either of said convex and concave surfaces.

26. A tool according to claim 19, wherein the receiving portion is formed substantially central of the operative portion.

27. A tool according to claim 26, wherein the receiving portion comprises a cut-away portion extending from the first end of the operative portion.

28. A tool according to claim 27, wherein the cut-away portion is of uniform width along its length.

29. A tool according to claim 27, wherein the cut-away portion is shaped in accordance with that of a specific article.

30. A tool according to claim 19, wherein the operative portion is in the form of a claw.

31. A tool according to claim 30, wherein the tool comprises a handle portion at said opposite end and attachable to said shaft.

32. A method for manipulating an article within a work-piece using the tool as claimed in claim 19, said method comprising the steps of:
engaging said article with said convex or concave surface; and
leveraging said article from said work-piece.
